(19) United States
(12) Patent Application Publication
(10) Pub. No.: US 2014/0370297 A1
(43) Pub. Date: Dec. 18, 2014

(54) CONDUCTIVE POLYMER COMPOSITION AND CONDUCTIVE FILM USING THE SAME

(71) Applicant: SAMSUNG ELECTRO-MECHANICS CO., LTD., Suwon (KR)

(72) Inventors: Jun Young Kim, Suwon (KR); Sung Nam Cho, Suwon (KR); Young Kwan Seo, Suwon (KR)

(73) Assignee: SAMSUNG ELECTRO-MECHANICS CO., LTD., Suwon (KR)

(21) Appl. No.: 14/041,892

(22) Filed: Sep. 30, 2013

(30) Foreign Application Priority Data
Jun. 18, 2013 (KR) 10-2013-0069461

(51) Int. Cl. H01B 1/12

(52) U.S. Cl. CPC H01B 1/127
USPC 428/412; 252/500; 428/515; 428/507; 428/473.5; 428/441; 428/483; 428/516; 428/523

(57) ABSTRACT

Disclosed herein is a conductive polymer composition capable of deteriorating water-absorption property and maintaining electrical conductivity by neutralizing polyethylenedioxythiophene/polystyrenesulfonate (PEDOT/PSS) with dicyclohexylmethylamine which is lipid-soluble tertiary amine, and a conductive film using the same.

### CROSS REFERENCE TO RELATED APPLICATION

This application claims the benefit of Korean Patent Application No. 10-2013-0069461, filed on Jun. 18, 2013, entitled “Conductive Polymer Composition and Conductive Film Using the Same”, which is hereby incorporated by reference in its entirety into this application.

### BACKGROUND OF THE INVENTION

1. Technical Field

The present invention relates to a conductive polymer composition and a conductive film using the same.

2. Description of the Related Art

A transparent electrode currently mainly used as a display is made of an indium-tin oxide (ITO), however, in the case in which the transparent electrode is made of ITO, excessive cost is required and a large area is difficult to be implemented. In particular, in the case in which the electrode having the large area is coated with ITO, change in a sheet resistance is large, which decreases brightness and light-emitting efficiency of the display. In addition, since a display market has expanded, indium, which is a main raw material of ITO, has been rapidly exhausted due to limited amount as a mineral. In order to resolve the above-described disadvantage of ITO, research into a transparent electrode formed by using a polyethylenedioxythiophene/polystyrenesulfonate (PEDOT/PSS) polymer having excellent flexibility and prepared by a simple coating process has been actively conducted.

Meanwhile, in the case in which the transparent electrode is made of the polyethylenedioxythiophene/polystyrenesulfonate (PEDOT/PSS) polymer, since the transparent electrode has a high sheet resistance at a level of 10⁵ to 10⁹ Ω/□, it is difficult to be used as a transparent electrode for a display. The high sheet resistance may be significantly decreased by adding dimethylsulfoxide (DMSO), ethyleneglycol, sorbitol, or the like, to a polyethylenedioxythiophene/polystyrenesulfonate (PEDOT/PSS) solution. However, according to the above-described method, the high sheet resistance may be decreased, but since PEDOT/PSS is a typical water-soluble polymer, the sheet resistance is changed by moisture-absorption, and at the time of being applied to an electronic device for a display, a serious problem occurs such as reliability of wet load resistance. Therefore, a method solving the moisture-absorption property obtained by using the PEDOT/PSS polymer as a conductive material has been strongly demanded.

### SUMMARY OF THE INVENTION

In the present invention, polyethylenedioxythiophene/polystyrenesulfonate (PEDOT/PSS) is neutralized with lipid-soluble tertiary amine to solve the above-described problems, thereby completing the present invention.

Therefore, the present invention has been made in an effort to provide a conductive polymer composition including: polyethylenedioxythiophene/polystyrenesulfonate (PEDOT/PSS) neutralized with lipid-soluble tertiary amine; a binder; and a solvent.

In addition, the present invention has been made in an effort to provide a conductive film prepared by using the conductive polymer composition according to the present invention.

According to a preferred embodiment of the present invention, there is provided a conductive polymer composition including: polyethylenedioxythiophene/polystyrenesulfonate (PEDOT/PSS) neutralized with lipid-soluble tertiary amine; a binder; and a solvent.

A content of the polyethylenedioxythiophene/polystyrenesulfonate (PEDOT/PSS) neutralized with lipid-soluble tertiary amine may be 0.5 to 50 wt %, a content of the binder may be 0.5 to 30 wt %, and a content of the solvent may be 20 to 95 wt %, based on 100 parts by weight of the conductive polymer composition.

The lipid-soluble tertiary amine may be dicyclohexylmethylamine.

One molecule of the dicyclohexylmethylamine may be reacted with one sulfonic acid group of the polyethylenedioxythiophene/polystyrenesulfonate (PEDOT/PSS).

The polyethylenedioxythiophene/polystyrenesulfonate (PEDOT/PSS) neutralized with the lipid-soluble tertiary amine may have a hydrogen ion concentration (pH) of 2.5 to 3.5.

The hydrogen ion concentration (pH) may be 2.9 to 3.1.

The hydrogen ion concentration (pH) may be 3.0.

The binder may be at least one selected from a group consisting of alkylglycidylether(meta)acrylate, phenylglycidylether(meta)acrylate, (meta)acrylate, a polyfunctional(meta)acrylate, an epoxy-based binder, a urethane-based binder, an acryl-urethane copolymer, a carboxyl-based binder, and an amide-based binder, having 2 to 8 carbon atoms.

The solvent may be at least one selected from a group consisting of polyalcohol, dimethylsulfoxide, N,N-dimethylformamide, ethyleneglycol, polyethyleneglycol, meso-erythritol, aniline, acetone, methylethylketone, isopropylalcohol, butylalcohol, ethylalcohol, methylalcohol, dimethylacetamide, hexane, toluene, chloroform, cyclohexanone, distilled water, pyridine, methylnaphthalene, tetrahydro furan, dichlorobenzene, dimethylbenzene, trimethylbenzene, nitromethane, acrylonitrile, and water (H₂O).

According to another preferred embodiment of the present invention, there is provided a conductive film including: a base member; and a transparent electrode formed by coating and drying the conductive polymer composition as described above on the base member.

The base member may be a single substrate selected from a group consisting of polycarbonate, polymethylmethacrylate, polyethyleneterephthalate, ethylenenaphthalate, polyethersulfone, a cyclic olefin polymer, a triacetylcellulose film, a polyvinylalcohol film, a polyimide film, polystyrene, biaxially oriented polystyrene, and a glass or a tempered glass, or a composite substrate manufactured by a combination thereof.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view schematically showing a structure of a general polyethylenedioxythiophene/polystyrenesulfonate (PEDOT/PSS) polymer;

FIG. 2 is a view showing moisture-absorption property generated by the general polyethylenedioxythiophene/polystyrenesulfonate (PEDOT/PSS) polymer;

FIG. 3 is a view showing a principle in which the polyethylenedioxythiophene/polystyrenesulfonate (PEDOT/PSS) polymer is neutralized with a lipid-soluble tertiary amine according to the preferred embodiment of the present invention;

FIG. 4 is a neutralization titration curve obtained by neutralizing the polyethylenedioxythiophene/polystyrenesulfonate (PEDOT/PSS) polymer with the lipid-soluble tertiary amine; and

FIG. 5 is a graph showing a change rate in a sheet resistance according to moisture-absorption of a sample fabricated by using the polyethylenedioxythiophene/polystyrenesulfonate (PEDOT/PSS) polymer with the lipid-soluble tertiary amine according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the prior art would obscure the gist of the present invention, the description thereof will be omitted.

Hereinafter, preferred embodiments of the present invention will be described in detail with reference to the attached drawings.

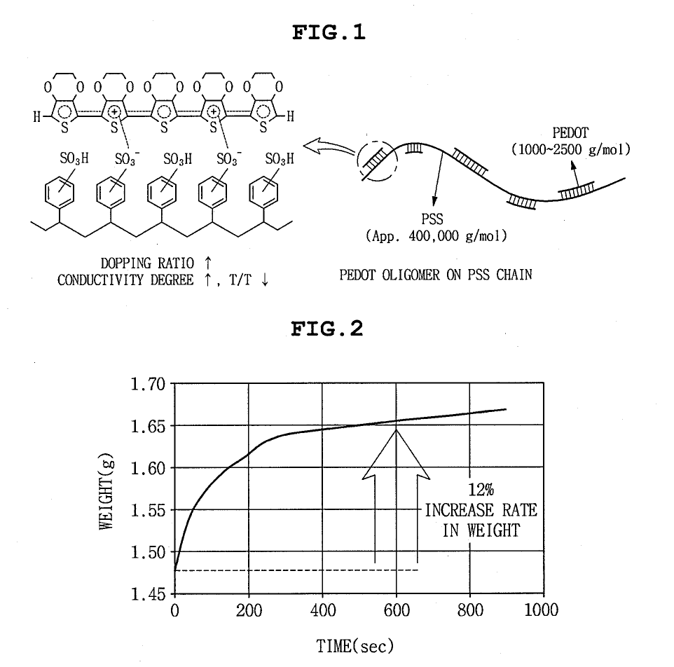

FIG. 1 is a view schematically showing a structure of a general poly(3,4-ethylenedioxythiophene)poly(styrenesulfonate (PEDOT/PSS) polymer. Referring to FIG. 1, PEDOT/PSS which is a conductive polymer consists of a PSS molecule having a long chain and a PEDOT molecule having a short chain, and one PEDOT/PSS polymer consist of one PSS molecule and several PEDOT molecules. PSS and PEDOT are combined with each other by an ionic bond. The PEDOT/PSS polymer has conductivity by the PEDOT molecule. However, the PEDOT molecule is not water-soluble, which deteriorates processability of PEDOT which is the conductive material. Meanwhile, PSS, which is a water-soluble polymer, has hydrophilic property and is easily dissolved in water. Therefore, PSS is ionic bonded to PEDOT to form a PEDOT/PSS polymer, such that PEDOT/PSS has water-dispersibility to thereby improve the processability. However, the hydrophilic property of PSS causes another problem, which is a moisture-absorption property, as a trade-off in relation with the processability of DEPOT/PSS.

FIG. 2 is a view explaining the moisture-absorption property of PEDOT/PSS. That is, FIG. 2 shows results by performing a water-uptake experiment on the PEDOT/PSS polymer under high humidity atmosphere, and it may be appreciated from FIG. 2 that weight of PEDOT/PSS is gradually increased over time, and after 600 seconds, the weight thereof is increased by about 12%. The weight increase is due to water that is absorbed by PEDOT/PSS. The moisture-absorption is caused by the hydrophilic property of PSS, and PSS is dissolved in water, such that the PEDOT molecules become dissociated.

The above-described problems may be solved by using lipid-soluble tertiary amine according to the preferred embodiment of the present inventors.

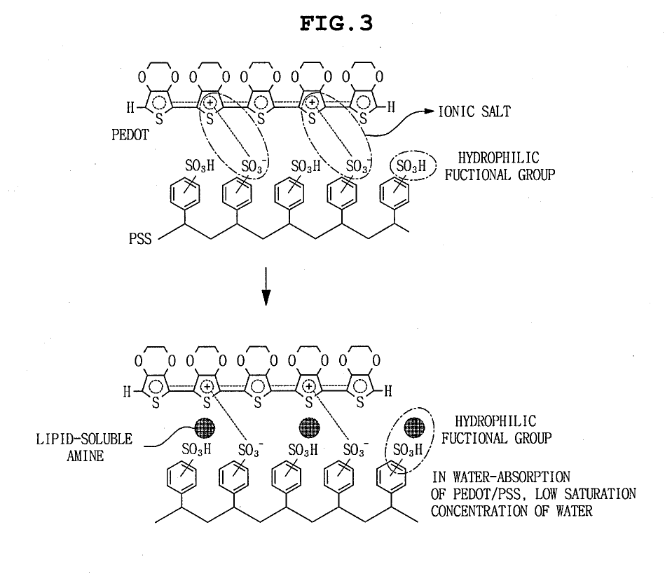

FIG. 3 is a view schematically showing a principle in which the general polyethylenedioxythiophene/polystyrenesulfonate (PEDOT/PSS) polymer is combined with the lipid-soluble tertiary amine to neutralize the lipid-soluble tertiary amine. That is, referring to FIG. 3, PSS has several sulfone (-SO₃H) groups, wherein some of the sulfone groups forms an ionic group with sulfur (S) of PEDOT. Meanwhile, the sulfone group present in PSS serves a functional group having hydrophilic property. That is, some of the sulfone groups present in PSS participate in a combination with PEDOT, but the remaining sulfone groups remain as they are, such that PSS is dissolved in water. Therefore, as described above, the present inventors found that the sulfone group not participating in the combination with PEDOT may be blocked from moisture, and the moisture-absorption property problem of the PEDOT/PSS polymer may be solved, and in particular, in the case of using the lipid-soluble tertiary amine to neutralize PSS, the moisture-absorption property problem and the problem that the conductivity is deteriorated may be simultaneously solved. That is, in the case in which the sulfone group is capped by amine, or the like, the general moisture-absorption property problem may be solved, but the sheet resistance is largely changed, such that reliability of a conductive device may not be secured. However, in the case in which the lipid-soluble tertiary amine is used to neutralize PEDOT/PSS according to the preferred embodiment of the present invention, a change rate in the sheet resistance may be minimized. In particular, a titration concentration for solving the moisture-absorption property problem and minimizing the change rate in the sheet resistance is significantly important, the present inventors found from a number of experiments that as a hydrogen ion concentration (pH) is close to 3.0, the change rate in the sheet resistance may be minimized.

Therefore, a conductive polymer composition according to the preferred embodiment of the present invention may contain polyethylenedioxythiophene/polystyrenesulfonate (PEDOT/PSS) neutralized with the lipid-soluble tertiary amine; a binder; and a solvent.

It is preferred that the conductive polymer composition contains 0.5 to 50 wt % of polyethylenedioxythiophene/polystyrenesulfonate (PEDOT/PSS) neutralized with lipid-soluble tertiary amine, 0.5 to 30 wt % of the binder, and 20 to 95 wt % of the solvent. In the case in which a weight ratio of PEDOT/PSS is less than 0.5%, the conductive polymer composition does not have conductivity, and in the case in which the weight ratio of PEDOT/PSS is more than 0.5%, there is a limitation in an added amount of the binder and the solvent to thereby deteriorate dispersibility of PEDOT/PSS. Meanwhile, in the case in which the added amount of the binder is less than 0.5 wt %, the processability of the conductive polymer composition is deteriorated, and in the case in which the added amount of the binder is more than 30 wt %, the conductive polymer composition does not have economical efficiency. In addition, in the case in which the added amount of the solvent is less than 20 wt %, the dispersibility and the processability of PEDOT/PSS are deteriorated, and in the case in which the added amount of the solvent is more than 95 wt %, there is a limitation in an added amount of PEDOT/PSS and the binder to thereby deteriorate conductivity and processability.

Meanwhile, examples of the binders used in the conductive polymer composition according to the preferred embodiment of the present invention may include alkylglycidylether(meta)acrylate, phenylglycidylether(meta)acrylate, (meta)acrylate, polyfunctional(meta)acrylate, an epoxy-based binder, a urethane-based binder, an acryl-urethane copolymer, a carboxyl-based binder, and an amide-based binder, having 2 to 8 carbon atoms, but the present invention is not limited thereto, and any binder may be used as long as the binder has compatibility with PEDOT/PPS.

In addition, examples of the solvent used in the conductive polymer composition according to the preferred embodiment of the present invention may include polyalcohol, dimethylsulfoxide, N,N-dimethylformamide, ethyleneglycol, polyethyleneglycol, meso-erythritol, aniline, acetone, methylethylketone, isopropylalcohol, butylalcohol, ethylalcohol, methylalcohol, dimethylacetamide, hexane, toluene, chloroform, cyclohexanone, distilled water, pyridine, methylnaphthalene, octamesylamine, tetrahydrofuran, dichlorobenzene, dimethylbenzene, trimethylbenzene, nitromethane, acrylonitrile, and water (H₂O), but the present invention is not limited thereto, and any solvent may be used as long as the solvent has compatibility with PEDOT/PPS and the binder.

It is preferred that amine used in the preferred embodiment of the present invention is lipid-soluble tertiary amine. In particular, dicyclohexylmethylamine among the lipid-soluble tertiary amine deteriorates the moisture-absorption property of PEDOT/PSS and significantly maintains conductivity. One molecule of dicyclohexylmethylamine is reacted with one sulfonic acid group of polyethylenedioxythiophene/polystyrenesulfonate (PEDOT/PSS). That is, as described above, one molecule of PSS has several sulfonic groups, some of the sulfonic groups participate in combination with PEDOT and the remaining sulfonic groups are maintained in a state in which they are exposed while having the hydrophilic property. The sulfonic group which is exposed while having the hydrophilic property as described above is combined with one molecule of dicyclohexylmethylamine to thereby form a salt. Meanwhile, the degree of the salt formation is capable of being adjusted, and hydrogen ion concentration (pH) of polyethylenedioxythiophene/polystyrenesulfonate (PEDOT/PSS) is determined by the number of sulfonic groups not combined with dicyclohexylmethylamine.

Meanwhile, the present inventors succeeded to find a critical section of the hydrogen ion concentration in which the moisture-absorption property may be the most effectively deteriorated and conductivity may be maintained through a number of experiments. That is, in the case in which the hydrogen ion concentration (pH) of polyethylenedioxythiophene/polystyrenesulfonate (PEDOT/PSS) neutralized with the lipid-soluble tertiary amine is 2.5 to 3.5, two effects, that are, the hydrophilic property deterioration and the conductive maintenance are maintained, in particular, it was evaluated that in the case in which the hydrogen ion concentration (pH) is 2.9 to 3.1, those effects were the most excellent.

In another preferred embodiment of the present invention, a conductive film may be fabricated by using the conductive polymer composition prepared according to the preferred embodiment of the present invention. The conductive film is fabricated by coating and drying the conductive polymer composition on a general base member. The base member may be made of a single substrate selected from a group consisting of polycarbonate (PC), polymethylmethacrylate (PMMA), polyethyleneterephthalate (PET), ethylenenaphthalate (PEN), polyether sulfone (PES), a cyclic olefin polymer (COC), a triacetylcellulose (TAC) film, a polyvinylalcohol (PVA) film, a polyimide (PI) film, polystyrene (PS), biaxially stretched polystyrene (K resin containing biaxially oriented PS; BOPS), glass or a tempered glass, or a composite substrate manufactured by a combination thereof. For example, the composite substrate indicates a substrate manufactured by using polymethylmethacrylate (PMMA) so as to have excellent hardness/transmittance which is an advantage thereof and using polycarbonate (PC) so as to supplement a vulnerable strength which is a disadvantage of PMMA. Here, PC may be the composite substrate manufactured by a combination such as PMMA/PC/PMMA, or the like, in which disadvantages of PMMA having excellent hardness/transmittance are supplemented.

Hereinafter, although the constitution and effects of the present invention have been specifically disclosed by the specific examples of the present invention, it will be appreciated that the following preferred examples are merely described for illustrative purposes, and the present invention is not limited thereto.

### EXAMPLE 1

A conductive polymer composition of Example 1 was prepared by slowly dropping dicyclohexylmethylamine into a binder alkylglycidylether(meta)acrylate and PEDOT/PSS aqueous dispersion 5305 AGFA Company, followed by stirring and neutralization up to pH 3.0.

### EXAMPLE 2

A conductive polymer composition of Example 2 was prepared by neutralization up to pH 2.9 under the same condition as Example 1.

### EXAMPLE 3

A conductive polymer composition of Example 3 was prepared by neutralization up to pH 3.1 under the same condition as Example 1.

### EXAMPLE 4

A conductive polymer composition of Example 4 was prepared by neutralization up to pH 2.5 under the same condition as Example 1.

### EXAMPLE 5

A conductive polymer composition of Example 5 was prepared by neutralization up to pH 2.6 under the same condition as Example 1.

### EXAMPLE 6

A conductive polymer composition of Example 6 was prepared by neutralization up to pH 2.7 under the same condition as Example 1.

### EXAMPLE 7

A conductive polymer composition of Example 7 was prepared by neutralization up to pH 2.8 under the same condition as Example 1.

### EXAMPLE 8

A conductive polymer composition of Example 8 was prepared by neutralization up to pH 3.2 under the same condition as Example 1.

### EXAMPLE 9

A conductive polymer composition of Example 9 was prepared by neutralization up to pH 3.3 under the same condition as Example 1.

### EXAMPLE 10

A conductive polymer composition of Example 10 was prepared by neutralization up to pH 3.4 under the same condition as Example 1.

### EXAMPLE 11

A conductive polymer composition of Example 11 was prepared by neutralization up to pH 3.5 under the same condition as Example 1.

### COMPARATIVE EXAMPLE 1

A conductive polymer composition of Comparative Example 1 was prepared by neutralization up to pH 2.0 to 2.4, and 3.6 to 3.9 under the same condition as Example 1.

Example 1 in Fabricating Conductive Film

A conductive film of Example 1 was obtained by applying the conductive polymer composition prepared by each Examples 1 to 11 on a polyethyleneterephthalate (PET) film using a bar coater and drying for 1 min at 100° C.

Comparative Example 1 in Fabricating Conductive Film

A conductive film of Comparative Example 1 was obtained by applying the conductive polymer composition prepared by Comparative Example 1 on the polyethyleneterephthalate (PET) film using a bar coater and drying for 1 min at 100° C.

The following Table 1 shows results obtained by measuring moisture-absorption degree and electrical conductivity using the sample fabricated by Example 1 and the sample fabricated by Comparative Example 1 in fabricating the conductive film. The moisture-absorption degree was obtained by putting the samples into a chamber having relative humidity of 85%, being exposed by moisture for 2 hours, and measuring an increase rate in weight of each sample, and the electrical conductivity was tested by using a silver paste electrode and measuring each sheet resistance.

TABLE 1

| | Moisture-Absorption | |
|---|---|---|
| Hydrogen Ion | Degree (Increase | Sheet |
| Concentration of | Rate in | Resistance |
| PEDOT/PSS (pH) | Weight, %) | (Relative Value) |
| 2.0 | 12 | 8.4 |
| 2.1 | 11.6 | 8.6 |
| 2.2 | 11 | 8.7 |
| 2.3 | 10.5 | 8.7 |
| 2.4 | 10.2 | 8.9 |
| 2.5 | 6 | 9.1 |
| 2.6 | 5.4 | 9.4 |
| 2.7 | 4.8 | 9.5 |
| 2.8 | 3.7 | 9.6 |
| 2.9 | 1.9 | 9.8 |
| 3.0 | 1.3 | 10.1 |
| 3.1 | 1.1 | 11.3 |
| 3.2 | 1.0 | 16.2 |
| 3.3 | 0.9 | 16.5 |
| 3.4 | 0.8 | 18.6 |
| 3.5 | 0.7 | 20.3 |
| 3.6 | 0.5 | 35 |
| 3.7 | 0.3 | 36.5 |
| 3.8 | 0.2 | 40.6 |
| 3.9 | 0.1 | 51.7 |

It may be appreciated from Table 1 above that after the hydrogen ion concentration of PEDOT/PSS reached to 2.5 or more, the moisture-absorption degree thereof was rapidly decreased, and in particular, after the hydrogen ion concentration thereof reached to 2.9 or more, the moisture-absorption degree was significantly decreased. In addition, it may be appreciated from the measurement results of the sheet resistance that there was no increase in the sheet resistance up to pH 3.1, but the sheet resistance increased from pH of 3.2, and in particular, rapidly increased from pH 3.6. Therefore, it may be appreciated from those experimental results that in the case in which PEDOT/PSS is neutralized with dicyclohexylamine, when it is titrated so that the hydrogen ion concentration has a preferred range of 2.5 to 3.5, and more preferably, 2.9 to 3.1, the moisture-absorption property may be deteriorated and electrical conductivity may be maintained. In particular, it may be appreciated from the data above that as the hydrogen ion concentration of PEDOT/PSS was close to 3.0, two effects, that is, the moisture-absorption property deterioration and conductivity maintenance were easily obtained.

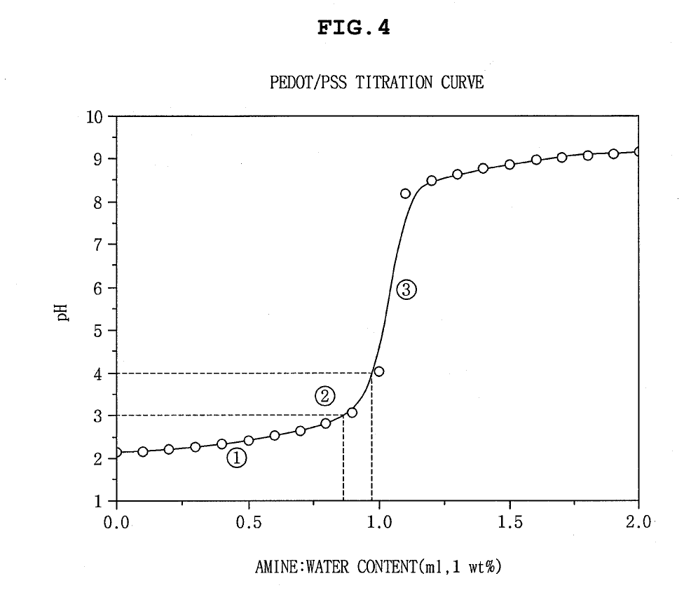

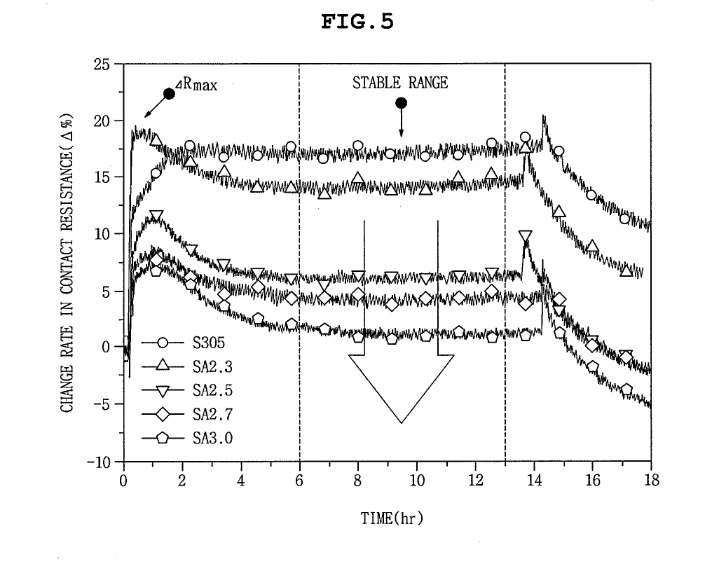

FIG. 4 is a graph showing a neutralization titration curve in the case of neutralizing the polyethylenedioxythiophene/polystyrenesulfonate (PEDOT/PSS) with the dicyclohexylmethylamine, and FIG. 5 is a graph showing the change rate in the sheet resistance for each sample. Results obtained by measuring the moisture-absorption degree and water-dispersibility of PEDOT/PSS in three regions (\textcircled{1}, \textcircled{2}, and \textcircled{3}) shown in FIG. 4 were shown in the following Table 2. The moisture-absorption degree was obtained by exposing the samples in a chamber having relative humidity of 85% for 2 hours and then measuring the increase rate in weight, and water-dispersibility was indirectly confirmed by measuring whether or not electrical conductivity of each portion of the samples were constant.

TABLE 2

| | Moisture-Absorption Degree | Water-Dispersibility |
|---|---|---|
| Region | (Increase Rate in Weight, %) | (Relative Value) |
| \textcircled{1} | 15-17 | 3.6 |
| \textcircled{2} | 9-13 | 2.4 |
| \textcircled{3} | 2-5 | 1.1 |

It may be appreciated from Table 2 above that in region \textcircled{1}, water-dispersibility was significantly excellent to have excellent processibility but the moisture-absorption degree was significantly high. Meanwhile, it may be appreciated that in region \textcircled{3}, the moisture-absorption degree was significantly decreased, but water-dispersibility was significantly decreased. However, it may be appreciated that in region ®, the moisture-absorption degree was decreased and water-dispersibility was favorably maintained.

Meanwhile, FIG. 5 is a graph showing results obtained by measuring the change rate in the sheet resistance according to moisture-absorption of the sample in the region \textcircled{2}. In FIG. 5, a test sample 5305 indicates a case of using non-neutralization PEDOT/PSS, and SA indicates a case of neutralizing PEDOT/PSS with the lipid-soluble tertiary amine according to the preferred embodiment of the present invention. The number followed by SA indicates a neutralized degree shown by the hydrogen ion concentration (pH). (That is, SA2.3 indicates a case of neutralizing PEDOT/PSS with the lipid-soluble tertiary amine so as to have pH 2.3, and SA3.0 indicates a case of neutralizing PEDOT/PSS with the lipid-soluble tertiary amine so as to have pH 3.0.) It may be appreciated from FIG. 5 that in the samples 5305 and SA2.3, the rapid increase rate in the sheet resistance was shown over time, and in the samples SA2.5, SA2.7, and SA3.0, the increased rate in the sheet resistance was relatively small over time. In particular, it may be appreciated that the sample SA3.0 neutralized to pH 3.0 had the smallest change rate in the sheet resistance, wherein the change rate in the sheet resistance in the stable range was almost zero (0). The above-described results are evaluated to have an innovative meaning in view of a matter that the moisture-absorption property problem is solved and the change in the sheet resistance is also solved by using amine to neutralize PEDOT/PSS.

As set forth above, with the conductive polymer composition and the conductive film using the same according to the preferred embodiment of the present invention, the lipid-soluble tertiary amine is used to neutralize polyethylenedioxythiophene/polystyrenesulfonate (PEDOT/PSS), thereby solving the moisture-absorption property caused by PEDOT/PSS according to the prior art, and solving the change in conductivity according to the moisture-absorption.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A conductive polymer composition comprising:
polyethylenedioxythiophene/polystyrenesulfonate (PEDOT/PSS) neutralized with lipid-soluble tertiary amine;
a binder; and
a solvent.

2. The conductive polymer composition as set forth in claim 1, wherein a content of the polyethylenedioxythiophene/polystyrenesulfonate (PEDOT/PSS) neutralized with lipid-soluble tertiary amine is 0.5 to 50 wt %, a content of the binder is 0.5 to 30 wt %, and a content of the solvent is 20 to 95 wt %, based on 100 parts by weight of the conductive polymer composition.

3. The conductive polymer composition as set forth in claim 1, wherein the lipid-soluble tertiary amine is dicyclohexylmethylamine.

4. The conductive polymer composition as set forth in claim 3, wherein one molecule of the dicyclohexylmethylamine is reacted with one sulfonic acid group of the polyethylenedioxythiophene/polystyrenesulfonate (PEDOT/PSS).

5. The conductive polymer composition as set forth in claim 1, wherein the polyethylenedioxythiophene/polystyrenesulfonate (PEDOT/PSS) neutralized with the lipid-soluble tertiary amine has a hydrogen ion concentration (pH) of 2.5 to 3.5.

6. The conductive polymer composition as set forth in claim 5, wherein the hydrogen ion concentration (pH) is 2.9 to 3.1.

7. The conductive polymer composition as set forth in claim 5, wherein the hydrogen ion concentration (pH) is 3.0.

8. The conductive polymer composition as set forth in claim 1, wherein the binder is at least one selected from a group consisting of alkylglycidylether(meta)acrylate, phenylglycidylether(meta)acrylate, (meta)acrylate, a polyfunctional(meta)acrylate, an epoxy-based binder, a urethane-based binder, an acyl-urethane copolymer, a carboxyl-based binder, and an amide-based binder, having 2 to 8 carbon atoms.

9. The conductive polymer composition as set forth in claim 1, wherein the solvent is at least one selected from a group consisting of polyalcohol, dimethylsulfoxide, N,N-dimethylformamide, ethyleneglycol, polyethyleneglycol, meso-erythritol, aniline, acetone, methylethylketone, isopropylalcoholm, butylalcohol, ethylalcohol, methylalcohol, dimethylacetamide, hexane, toluene, chloroform, cyclohexanone, distilled water, pyridine, methylnaphthalene, octamesylamine, tetrahydrofuran, dichlorobenzene, dimethylbenzene, trimethylbenzene, nitromethane, acrylonitrile, and water (H₂O).

10. A conductive film comprising:
a base member; and
a transparent electrode formed by coating and drying the conductive polymer composition as set forth in any one of claims 1 to 9 on the base member.

11. The conductive film as set forth in claim 10, wherein the base member is a single substrate selected from a group consisting of polycarbonate, polymethylmethacrylate, polyethyleneterephthalate, ethylenenaphthalate, polyethersulfone, a cyclic olefin polymer, a triacetylcellulose film, a polyvinylalcohol film, a polyimide film, polystyrene, biaxially oriented polystyrene, and a glass, or a composite substrate manufactured by a combination thereof.
